(19) United States
(12) Patent Application Publication
(10) Pub. No.: US 2006/0029017 A1
(43) Pub. Date: Feb. 9, 2006

(54) Method and system for transmitting training information in a block transmission system

(75) Inventors: Sriram Mudulodu, Milpitas, CA (US); Krishnamurthy Giridhar, Chennai (IN)

Correspondence Address: Beceem Communications Inc., 3930 Freedom Circle #101, Santa Clara, CA, 95054, US

(73) Assignee: Beceem Communications Inc., Santa Clara, CA (US)

(21) Appl. No.: 11/188,476

(22) Filed: Jul. 25, 2005

Related U.S. Application Data
(60) Provisional application No. 60/591,318, filed on Jul. 26, 2004.

(51) Int. Cl. H04Q 7/00

(52) U.S. Cl. 370/328

(57) ABSTRACT

A method and system for transmitting training information in a block transmission system such as Orthogonal Frequency-Division Multiplexing (OFDM), Multi-Carrier Code Division Multiple Access (MC-CDMA) systems, is provided. The method includes transmitting an information bearing unit, which may be a preamble, midamble or postamble, to enable the receiver to synchronize, and obtain channel estimates. It is suitable for both single and multiple antenna wireless systems.

### RELATED APPLICATION DATA

This application claims the priority date of U.S. Provisional Ser. No. 60/591,318 filed Jul. 26, 2004, entitled “PREAMBLE STRUCTURES FOR MOBILE AND FIXED CELLULAR SYSTEMS”.

### BACKGROUND

The invention generally relates to block transmission systems. More specifically, the invention relates to a method and system for transmitting training information in a block transmission system.

In known block transmission systems, the training information such as a preamble includes a cell identifier based on which the receiver identifies a base station. A cell identifier generally refers to a sequence based on which a receiver identifies a base station. The preamble is used for synchronizing the receiver. The method of synchronization involves obtaining timing offset estimate and frequency offset estimate along with the cell identifier, which requires substantial receiver complexity.

The preamble in such systems, is transmitted by a first transmit antenna. Further, some of the control information and/or broadcast information is transmitted by the first transmit antenna alone. This includes the information regarding the number of transmit antennas in a base station.

There is therefore a need for a method and system that reduces the computation involved in synchronizing the receiver. Further, there is a need for a method and system that enables transmission of control information and/or broadcast information through a plurality of transmit antennas.

### SUMMARY

An objective of the invention is to provide a method and system that simplifies synchronization of a receiver.

Another objective of the invention is to enable the receiver to determine a number of transmit antennas of a base station based on an information bearing unit.

In order to fulfill the above-mentioned objectives, a method for transmitting training information in a block transmission system is provided. The method includes transmitting an information bearing unit. The information bearing unit is transmitted by at least one transmit antenna and can be one of preamble, midamble, or postamble. In an embodiment of the invention, the information bearing unit includes a predetermined identifier and a cell identifier. In an embodiment of the invention, the frequency domain sub-carriers of the predetermined identifier are spaced apart by twice the number of sectors in a cell. Also, the sub-carriers on which the predetermined identifier is transmitted in adjacent sectors are shifted by an even integer. As a result, symbol corresponding to the predetermined identifier as received by a receiver is periodic at each point in the cell.

### BRIEF DESCRIPTION OF THE DRAWINGS

A more complete appreciation of the invention and the attended advantages will become readily apparent as the same becomes better understood by reference of the following detailed description when considered in conjunction with the accompanying drawings in which reference symbols indicate the same or similar components, wherein:

FIG. 1 is a flowchart of a method for synchronizing a receiver in a block transmission system, in accordance with an embodiment of the invention.

FIG. 2 is a flowchart of a method for synchronizing a receiver in a block transmission system, in accordance with another embodiment of the invention.

FIG. 3 shows the sub-carriers on which a predetermined identifier is transmitted in a plurality of sectors of a cell, when the number of sectors in a cell is three, in accordance with an exemplary embodiment of the invention.

FIG. 4 is a flowchart of a method for determination of number of transmit antennas of a base station in a block transmission system, in accordance with an embodiment of the invention.

FIG. 5 is a block diagram of a system for synchronizing a receiver in a block transmission system, in accordance with an embodiment of the invention.

### DETAILED DESCRIPTION OF DRAWINGS

The invention provides a method and system for transmitting training information in a block transmission system. Examples of block transmission include Orthogonal Frequency-Division Multiplexing (OFDM), Multi-Carrier Code Division Multiple Access (MC-CDMA), Discrete Multi-Tone (DMT) and the like. The IEEE 802.16d and 802.16e wireless Metropolitan Area Network (MAN) standards, which use OFDM-like technology, also fall in this category. In various embodiments of the invention, the block transmission system is a frequency reuse system. In an exemplary embodiment of the invention, the block transmission system is a frequency reuse-1 system.

The method for transmitting training information in the block transmission system includes transmitting an information bearing unit. The information bearing unit is transmitted by at least one transmit antenna of a base station. In an embodiment of the invention, the information bearing unit is a preamble. In another embodiment of the invention, the information bearing unit may be a midamble or postamble.

In an embodiment of the invention, the information bearing unit includes a cell identifier and a predetermined identifier. A cell identifier is generally referred to as a sequence based on which a receiver identifies a base station. In an exemplary embodiment of the invention, the cell identifier is a binary sequence of −1 s and +1 s and has a predefined length. For example, in 802.16e/d standards, the cell identifier of a base station is selected from a set of 114 binary sequences. The predetermined identifier is another sequence like the cell identifier.

In various embodiments of the invention, the information bearing unit further includes at least one training sequence. The training sequence is known to the receiver and may be used for training at least one transmit antenna.

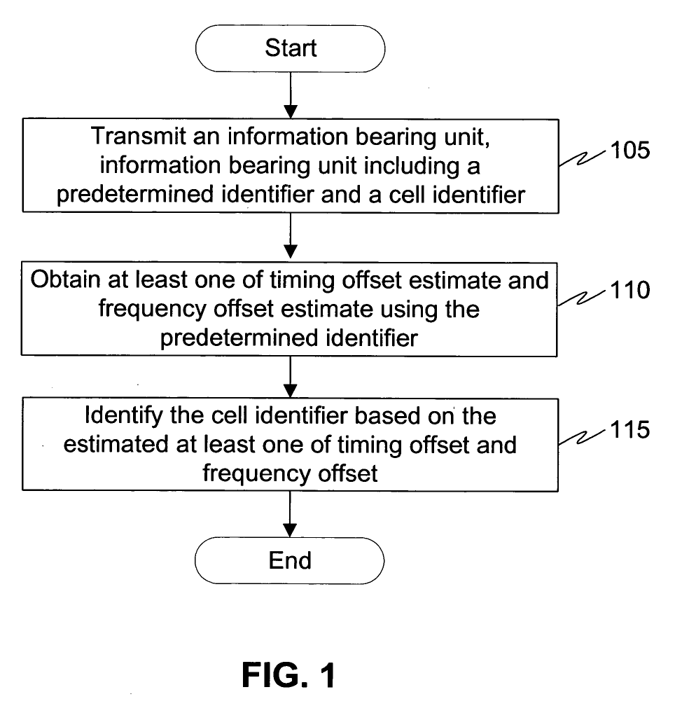

In various embodiments of the invention, a receiver is synchronized based on the information bearing unit. This is further explained in conjunction with FIG. 1. The receiver may have a plurality of receive antennas. The method of synchronization may include performing base station acquisition/cell identification and active set determination. Active set determination generally refers to obtaining a list of base stations ranked according to their signal strengths.

FIG. 1 is a flowchart of a method for synchronizing a receiver in a block transmission system, in accordance with an embodiment of the invention. At step 105, an information bearing unit is transmitted by at least one transmit antenna. At step 110, timing offset estimate and frequency offset estimate is obtained using the predetermined identifier. In an embodiment of the invention, either the timing offset estimate or the frequency offset estimate is obtained at the receiver, using the predetermined identifier.

In another embodiment of the invention, if the symbol corresponding to the predetermined identifier as received by the receiver is periodic, periodicity is used in simplifying the method of obtaining the timing offset estimate and the frequency offset estimate. As a result, the periodicity helps in reducing the complexity of the method of synchronization. For example, a coarse estimate of the timing offset can be obtained by using the periodicity, before obtaining the fine estimate of the timing offset. The periodicity may also be used for estimating the fractional frequency offset.

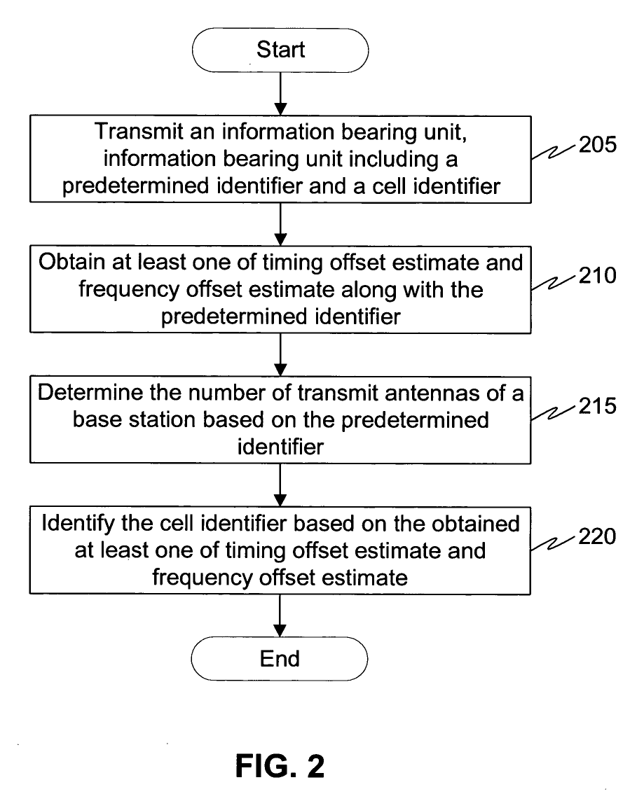

In an embodiment of the invention, timing offset estimate and/or frequency offset estimate is obtained based on the predetermined identifier, if the predetermined identifier is known to the receiver. In another embodiment of the invention, timing offset estimate and/or frequency offset estimate is obtained along with the predetermined identifier, if the predetermined identifier is unknown to the receiver. In various embodiments of the invention, the predetermined identifier is selected by the base station from a predefined set. This is further explained below in conjunction with FIG. 2.

At step 115, the cell identifier is identified by the receiver based on the obtained at least one of timing offset estimate and frequency offset estimate. Therefore, the transmission of the predetermined identifier simplifies the method of synchronization.

In various embodiments of the invention, the frequency offset is corrected based on the obtained frequency offset estimates.

FIG. 2 is a flowchart of a method for synchronizing a receiver in a block transmission system, in accordance with another embodiment of the invention. At step 205, an information bearing unit is transmitted by at least one transmit antenna. At step 210, timing offset estimate and/or frequency offset estimate is obtained along with the predetermined identifier, at the receiver. The predetermined identifier is selected by the base station from a predefined set based on the number of transmit antennas. At step 215, the number of transmit antennas of the base station is determined by the receiver based on the predetermined identifier. Each identifier within the predefined set corresponds to a different number of transmit antennas. This enables hand-off between base stations comprising different number of transmit antennas.

At step 220, the cell identifier is identified by the receiver based on the obtained at least of timing offset estimate and frequency offset estimate. In various embodiments of the invention, the information bearing unit can further be used for performing channel estimation for each transmit antenna-receive antenna pair.

In various embodiments of the invention, control information or broadcast information can also be transmitted using a plurality of transmit antennas as the number of transmit antennas of the base station is determined by the receiver based on the predetermined identifier. The control information may be, for example, but not limited to, indicative of a specific mode of transmission, a service provider, or a combination thereof.

In various embodiments of the invention, the sub-carriers of a symbol on which a transmit antenna transmits is shifted by a predefined number with respect to the sub-carriers of the symbol on which a remaining transmit antenna transmits if the number of transmit antennas is at least two. The predefined number is equal to the number of sectors in the cell. For example, the sub-carriers of a symbol on which a second transmit antenna transmits is shifted by three (if the number of sectors is equal to three) with respect to the sub-carriers of the symbol on which a first transmit antenna transmits. Similarly, the sub-carriers of a symbol on which a third transmit antenna transmits is shifted by three with respect to the sub-carriers of the symbol on which the second transmit antenna transmits, if the number of transmit antennas transmitting on the symbol is at least three.

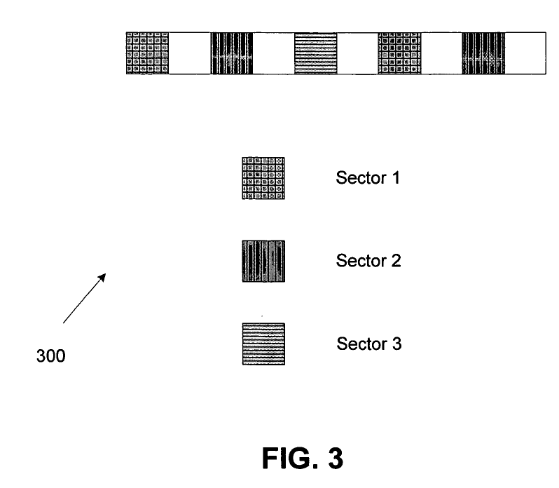

In an embodiment of the invention, the frequency domain sub-carriers of the predetermined identifier are spaced apart by twice the number of sectors in the cell. Further, the sub-carriers on which the predetermined identifier is transmitted in adjacent sectors are shifted by an even integer with respect to each other. Therefore, the symbol corresponding to the predetermined identifier as received by a receiver is periodic at each point in the cell even in the presence of interference from other base stations. This embodiment is herein after referred to as a periodic-predetermined-identifier-embodiment. This is explained in conjunction with FIG. 3, which corresponds to the case when the number of sectors in a cell is three.

FIG. 3 shows the sub-carriers on which a predetermined identifier is transmitted in a plurality of sectors of a cell, when the number of sectors in a cell is equal to three, in accordance with an exemplary embodiment of the invention. The sub-carriers of the predetermined identifier are spaced apart by six. The sub-carriers on which the predetermined identifier is transmitted in the sectors of a cell are shown at 300. As shown at 300, the sub-carriers on which the predetermined identifier is transmitted in the adjacent sectors are shifted by two or four with respect to each other. For example, the sub-carriers on which the predetermined identifier is transmitted in sector 1 and in sector 2 are shifted by two with respect to each other and the sub-carriers on which the predetermined identifier is transmitted in sector 1 and in sector 3 are shifted by four. As a result, the symbol corresponding to the predetermined identifier as received by a receiver is periodic at each point in the cell even in the presence of interference from other base stations. This helps in further simplifying synchronization of the receiver.

In the periodic-predetermined-identifier-embodiment, the information bearing unit is transmitted on a first symbol and a second symbol. The first symbol is used to transmit only the predetermined identifier from the first transmit antenna. The cell identifier is transmitted in the second symbol by one of the transmit antennas.

In the periodic-predetermined-identifier-embodiment, if the number of transmit antennas in a particular sector is equal to one and the number of sectors in a cell is equal to three, the sub-carriers on which the transmission occurs on the second symbol are spaced apart by six and shifted by three with respect to the first symbol. The pilot spacing of the sub-carriers for the transmit antenna is therefore three.

In the periodic-predetermined-identifier-embodiment, if the number of transmit antennas in a particular sector is equal to two and the number of sectors in a cell is equal to three, the sub-carriers on which the transmission occurs from a given transmit antenna in the second symbol are spaced apart by six. Further, the sub-carriers on which the transmission occurs from the first transmit antenna on the second symbol is shifted by three with respect to the sub-carriers on which the predetermined identifier is transmitted. Also, the sub-carriers of the second symbol on which a second transmit antenna transmits is shifted by three with respect to the sub-carriers of the second symbol on which the first transmit antenna transmits. Therefore, the pilot spacing of the sub-carriers for the first transmit antenna is three and for the second transmit antenna is six.

In the periodic-predetermined-identifier-embodiment, if the number of transmit antennas in a particular sector is equal to three and the number of sectors in a cell is equal to three, only the second transmit antenna and a third transmit antenna transmit on the second symbol. Further, the sub-carriers on which the transmission occurs from a given transmit antenna on the second symbol are spaced apart by six. Also, the sub-carriers of the second symbol on which the second transmit antenna transmits are shifted by three with respected to the sub-carriers on which the third transmit antenna transmits. The pilot spacing for each of the three transmit antennas in the sector is therefore six.

In the periodic-predetermined-identifier-embodiment, if the number of transmit antennas in a particular sector is equal to four and the number of sectors in a cell is equal to three, only the second transmit antenna, the third transmit antenna and a fourth transmit antenna transmit on the second symbol. Further, the sub-carriers on which the transmission occurs from a given transmit antenna on the second symbol are spaced apart by nine. Also, the sub-carriers of the second symbol on which the second transmit antenna transmits are shifted by three with respected to the sub-carriers on which the third transmit antenna transmits. Also, the sub-carriers of the second symbol on which the third transmit antenna transmits are shifted by three with respected to the sub-carriers on which the fourth transmit antenna transmits. The pilot spacing for the first transmit antenna of this sector is therefore six, and for the remaining transmit antennas of this sector is therefore nine.

In various embodiments of the invention, the length of the cell identifier is dependent on the maximum number of transmit antennas per sector of the block transmission system. In the periodic-predetermined-identifier-embodiment, if the number of transmit antennas in a particular sector is less than the maximum number of transmit antennas, the transmit antenna that transmits the cell identifier can also further transmit a training sequence in the second symbol.

In various embodiments of the invention, the information bearing unit is transmitted in at least one symbol. If the number of transmit antennas is equal to one, the predetermined identifier and the cell identifier are transmitted simultaneously in one symbol using a first transmit antenna. The sub-carriers on which the predetermined identifier is transmitted is shifted with respect to the sub-carriers on which the cell identifier is transmitted by a number equal to the number of sectors in a cell. In an exemplary embodiment of the invention, if the number of the sectors is equal to three, the sub-carriers of the predetermined identifier are spaced apart by six and the sub-carriers of the cell identifier are spaced apart by six on the first transmit antenna. The pilot spacing for the first transmit antenna is therefore three sub-carriers.

If the number of transmit antennas is at least two, the predetermined identifier is transmitted by a first transmit antenna and the cell identifier is transmitted by a second transmit antenna on one symbol. In an exemplary embodiment of the invention, if the number of the sectors is equal to three, the sub-carriers of the predetermined identifier are spaced apart by six on a first transmit antenna and the sub-carriers of the cell identifier are spaced apart by six on a second transmit antenna, if the number of antennas is at least two. Also, the sub-carriers on which the second transmit antenna transmits is shifted by three with respect to the sub-carriers on which the first transmit antenna transmits. The pilot spacing for the first transmit antenna and the second transmit antenna is therefore six sub-carriers.

In an embodiment of the invention, the information bearing unit further includes at least one training sequence, if the number of transmit antennas is at least three. In this embodiment of the invention, the predetermined identifier and the cell identifier are transmitted on a first symbol and at least one training sequence is transmitted on a second symbol. For example, the information bearing unit includes a first training sequence and a second training sequence. If the number of transmit antennas is equal to three, the first training sequence helps obtain the channel estimates corresponding to the first transmit antenna and the second training sequence is used to obtain the channel estimates corresponding to a third transmit antenna. Further, the sub-carriers on which the first sequence is transmitted is shifted by three (if the number of the sectors is equal to three) with respect to the sub-carriers on which the predetermined identifier is transmitted. Also, the sub-carriers of the second symbol on which the third transmit antenna transmits are shifted by three with respect to the sub-carriers of the second symbol on which the first transmit antenna transmits. For this case, the pilot spacing for the first transmit antenna is three, and for the second transmit antenna and third transmit antenna is six. If the number of transmit antennas is equal to four, the first training sequence is used to obtain the channel estimates corresponding to a third transmit antenna and the second training sequence is used to obtain the channel estimates corresponding to a fourth transmit antenna. In this case, each transmit antenna has a pilot spacing of six sub-carriers.

In various embodiments of the invention, the pilot spacing of the transmit antennas is good and there is no interference from the neighboring sectors or from different transmit antennas of the same sector. Therefore the quality of the channel estimation is good.

In various embodiments of the invention, each identifier within the predefined set is selected such that the Peak-to-Peak Average Ratio (PAPR) of the signal of the transmit antenna from which it is transmitted is low. This allows the transmit power on the transmit antenna corresponding to the symbol on which the predetermined identifier is transmitted, to be increased, thereby improving coverage and performance. For example, when the number of sectors is equal to three, and the Fast Fourier Transform (FFT) size is 1024, and the left and the right guard band size is 87, the predetermined identifier can be chosen to have a PAPR for the transmit signal corresponding to the symbol as low as 3.5. Similarly, the other sequences such as the cell identifier and training sequences can also be chosen to have a low PAPR.

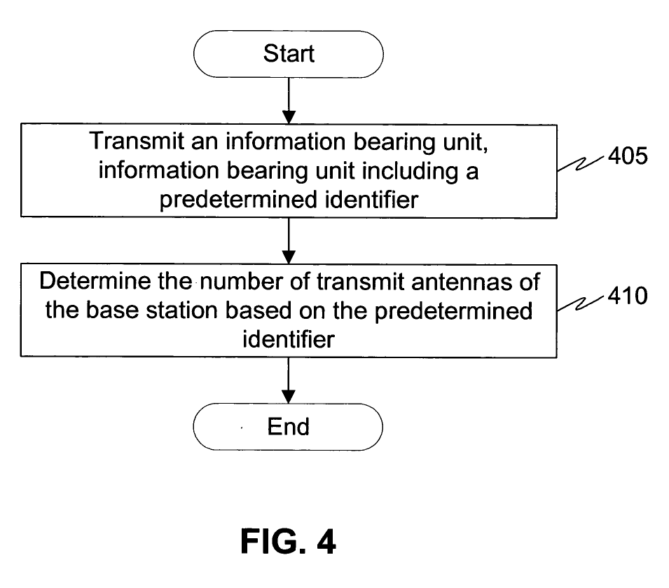

FIG. 4 is a flowchart for determining number of transmit antennas of a base station in block transmission system, in accordance with an embodiment of the invention. At step 405, an information bearing unit is transmitted. The information bearing unit includes a predetermined identifier. The predetermined identifier is selected by the base station from a predefined set based on the number of transmit antennas. At step 410, the number of transmit antennas are determined based on the predetermined identifier by the receiver. Each identifier within the predefined set corresponds to a different number of transmit antennas.

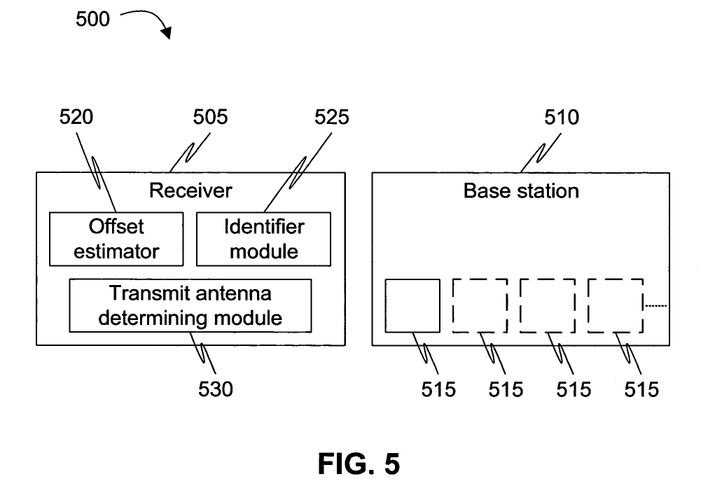

FIG. 5 is a block diagram of a system for synchronizing a receiver 505 in a block transmission system 500, in accordance with an embodiment of the invention. Block transmission system 500 includes a plurality of base stations 510. In various embodiments of the invention, block transmission system 500 is a frequency reuse system. In an exemplary embodiment of the invention, block transmission system 500 is a frequency reuse-1 system.

Each base station includes at least one transmit antenna 515. The system for synchronizing receiver 505 includes at least one transmit antenna 515, an offset estimator 520, an identifier module 525 and a transmit antenna determining module 530.

At least one transmit antenna 515 transmits an information bearing unit. The information bearing unit includes a cell identifier and a predetermined identifier. Offset estimator 520 obtains at least one of timing offset estimate and frequency offset estimate using the predetermined identifier. In an embodiment of the invention, offset estimator 520 obtains at least one of timing offset estimate and frequency offset estimate based on the predetermined identifier, if the predetermined identifier is known to the receiver.

In an embodiment of the invention, offset estimator 420 also corrects for obtained offset estimates.

In an embodiment of the invention, offset estimator 520 obtains at least one of timing offset estimate and frequency offset estimate along with the predetermined identifier. The predetermined identifier is selected from a predefined set. Transmit antenna determining module 530 determines the number of transmit antennas 515 of a base station 510 based on the predetermined identifier. This has been explained in detail in conjunction with FIG. 2 and FIG. 4. Each identifier within the predefined set corresponds to a different number of transmit antennas. This enables hand-off between base stations comprising different number of transmit antennas.

Identifier module 525 identifies the cell identifier based on the estimated at least one of timing offset estimate and frequency offset estimate.

In various embodiments of the invention, offset estimator 520, identifier module 525 and transmit antenna determining module 530 reside on receiver 505. In an embodiment of the invention, these modules may interact with one another. In an embodiment of the invention, offset estimator 520, identifier module 525 and transmit antenna determining module 530 can be integrated into a single module.

The various embodiments of the invention provide a method and system that simplifes synchronization of a receiver. Further, the various embodiments of the invention provide a method and system in which the symbol corresponding to the predetermined identifier is periodic in time domain at each point in the cell as received by a receiver. This further simplifies the method of synchronization.

The various embodiments of the invention provide a method and system in which both the synchronization of the receiver is simplified and good quality channel estimates can be obtained even in the presence of multiple transmit antennas and inter-cell interference.

The various embodiments of the invention provide a method and system that enable a receiver to determine a number of transmit antennas of a base station based on a predetermined identifier. As a result, the control information can be transmitted using a plurality of transmit antennas. Further, this enables hand-off between base stations comprising different number of transmit antennas.

What is claimed is:

1. A method for transmitting training information in a block transmission system, the block transmission system being a frequency reuse system, the method comprising the step of transmitting an information bearing unit, the information bearing unit being transmitted by at least one transmit antenna, the information bearing unit being one of preamble, midamble, or postamble, the information bearing unit comprising a predetermined identifier and a cell identifier, the sub-carriers of the predetermined identifier transmitted by a base station in a sector being spaced apart by twice the number of sectors in a cell, the sub-carriers on which the predetermined identifier is transmitted in adjacent sectors being shifted by an even integer, wherein symbol corresponding to the predetermined identifier as received by a receiver is periodic at each point in the cell.

2. The method of claim 1, wherein the frequency domain sub-carriers of the predetermined identifier are spaced apart by six if the number of sectors in the cell is equal to three.

3. The method of claim 1, wherein the predetermined identifier is transmitted in a first symbol by a first transmit antenna, and the cell identifier is transmitted in a second symbol.

4. The method of claim 3, wherein the sub-carriers of the second symbol on which a transmit antenna transmits is shifted by a predefined number with respect to the sub-carriers of the second symbol on which a remaining transmit antenna transmits if the number of transmit antennas is at least two, wherein the predefined number is equal to the number of sectors in a cell.

5. The method of claim 3, wherein the sub-carriers of the second symbol on which the first transmit antenna transmits is shifted by three with respect to the sub-carriers on which the predetermined identifier is transmitted, if the number of transmit antennas is equal to two.

6. The method of claim 3, wherein the information bearing unit further comprises at least one training sequence, the at least one training sequence training at least one transmit antenna.

7. The method of claim 1, whereby the pilot spacing on a transmit antenna is at most nine, if the number of transmit antenna is equal to four, and is at most six if the number of transmit antenna is equal to three.

8. The method of claim 1, whereby the information bearing unit provides channel estimates corresponding to a transmit antenna of a sector, that are free from interference from neighboring sectors and are free from interference from remaining transmit antennas in the sector.

9. A method for synchronizing a receiver in a block transmission system, the block transmission system being a frequency reuse system, the method comprising the steps of:
a. transmitting an information bearing unit, the information bearing unit being transmitted by at least one transmit antenna, the information bearing unit comprising a predetermined identifier and a cell identifier;
b. obtaining at least one of timing offset estimate and frequency offset estimate using the predetermined identifier; and
c. identifying the cell identifier based on the estimated at least one of timing offset estimate and frequency offset estimate;
whereby, the transmission of the predetermined identifier simplifies the method of synchronization.

10. The method of claim 9, wherein the information bearing unit is transmitted in at least one symbol.

11. The method of claim 9, wherein the at least one offset is estimated by using the periodicity of the symbol corresponding to the predetermined identifier as received by the receiver.

12. The method of claim 9, wherein the at least one of timing offset estimate and frequency offset estimate is obtained based on the predetermined identifier.

13. The method of claim 9, wherein the at least one of timing offset estimate and frequency offset estimate is obtained along with the predetermined identifier.

14. The method of claim 13 further comprising the step of determining the number of transmit antennas of a base station, the receiver interacting with the base station, the number of transmit antennas being determined based on the predetermined identifier, wherein the predetermined identifier is selected from a predefined set, the predefined set comprises a plurality of identifiers, each identifier corresponds to a different number of transmit antennas.

15. The method of claim 14, wherein the sub-carriers of a symbol on which a transmit antenna transmits is shifted by a predefined number with respect to the sub-carriers of the symbol on which a remaining transmit antenna transmits if the number of transmit antennas is at least two, wherein the predefined number is equal to the number of sectors in a cell.

16. The method of claim 14, wherein the predetermined identifier and the cell identifier are transmitted simultaneously if the number of transmit antennas is equal to one, the predetermined identifier and the cell identifier being transmitted in one symbol.

17. The method of claim 14, wherein the predetermined identifier is transmitted by a first transmit antenna and the cell identifier is transmitted by a second transmit antenna if the determined number of transmit antennas is at least two, the predetermined identifier and the cell identifier being transmitted in one symbol.

18. The method of claim 14, wherein the information bearing unit further comprises at least one training sequence if the determined number of transmit antennas is at least three, the at least one training sequence training at least one transmit antenna from the determined number of transmit antennas.

19. The method of claim 18, wherein the information bearing unit comprises a first training sequence and a second training sequence, the first training sequence training the first transmit antenna and the second training sequence training a third transmit antenna if the determined number of transmit antennas is equal to three, the sub-carriers on which the first training sequence is transmitted is shifted by three with respect to the sub-carriers on which the predetermined identifier is transmitted if the number of sectors in a cell is equal to three, the predetermined identifier and the cell identifier being transmitted in a first symbol, the first training sequence and the second training sequence being transmitted in a second symbol.

20. A method for determining number of transmit antennas of a base station in a block transmission system, the block transmission system being a frequency reuse system, the method comprising the steps of:
a. transmitting an information bearing unit, the information bearing unit being transmitted by at least one transmit antenna, the information bearing unit comprising a predetermined identifier; and
b. determining the number of transmit antennas of the base station, the number of transmit antennas being determined based on the predetermined identifier, wherein the predetermined identifier is selected from a predefined set, the predefined set comprises a plurality of identifiers, each identifier corresponds to a different number of transmit antennas.

21. A system for synchronizing a receiver in a block transmission system, the block transmission system being a frequency reuse system, the system comprising:
a. at least one transmit antenna, the at least one transmit antenna transmitting an information bearing unit, the information bearing unit comprising a predetermined identifier and a cell identifier;
b. an offset estimator, the offset estimator obtaining at least one of timing offset estimate and frequency offset estimate using the predetermined identifier, the offset estimator residing on the receiver; and
c. an identifier module, the identifier module identifying the cell identifier based on the estimated at least one of timing offset estimate and frequency offset estimate, the identifier module residing on the receiver.

22. The system of claim 21, wherein the block transmission system is a frequency reuse-1 system.

23. The system of claim 21, further comprising a transmit antenna determining module, the transmit antenna determining module determining the number of transmit antennas of a base station, the receiver interacting with the base station, the number of transmit antennas being determined based on the predetermined identifier, wherein the predetermined identifier is selected from a predefined set, the predefined set comprises a plurality of identifiers, each identifier corresponds to a different number of transmit antennas, the transmit antenna determining module residing on the receiver.

24. The system of claim 23, whereby hand-off is enabled between base stations comprising different number of transmit antennas.
